(19) United States
(12) Patent Application Publication
(10) Pub. No.: US 2017/0258263 A1
(43) Pub. Date: Sep. 14, 2017

(54) Capsule holder

(71) Applicant: CAPITANI S.R.L., Solbiate (CO) (IT)

(72) Inventor: Gionata CAPITANI, Albiolo (CO) (IT)

(21) Appl. No.: 15/453,377

(22) Filed: Mar. 8, 2017

(30) Foreign Application Priority Data
Mar. 8, 2016 (IT) 102016000024210

(51) Int. Cl. A47J 31/40; A47J 31/44

(52) U.S. Cl. CPC A47J 31/407; A47J 31/4403

(57) ABSTRACT

Disclosed is a capsule container for producing an infused beverage by an infusion assembly operating with a capsule or pod containing an aromatic substance. At least one output passage for the infused beverage is obtained in the capsule container. Such output passage is engaged by a valve member axially translatable between a closed position of the output passage, when there is no capsule in the container, and an open position of the output passage when there is a capsule in the container.

### DESCRIPTION OF THE INVENTION

The present invention concerns a capsule container for producing an infused beverage by an infusion assembly operating with a capsule or pod containing an aromatic substance. According to the preamble of claim 1, the capsule container is of the type delimiting a capsule housing compartment adapted to receive a capsule or pod by shape coupling therewith and having a bottom wall in which at least one output passage for the infused beverage is obtained.

The present invention is particularly suitable for being applied to a capsule adapter that can be inserted in the female infuser of an infusion assembly to use capsules of different size or shapes, for example of the type described in the Application No. EP3114970 in the name of the same Applicant, or to a capsule-holder with a handle adapted to be connected to a machine for producing an infused beverage.

A problem of these adapters and capsule-holder, which is particularly evident in case of capsules having high volumes, for example 14 g product grammage, is that when the infusion assembly is opened for extracting the used capsule, air enters the infusion chamber and causes the beverage to leak out from the machine hopper or the capsule-holder.

Object of the present invention is to propose a capsule container, in particular an adapter or a capsule-holder, able to obviate the above reported drawback. Said object is achieved by a capsule container according to claim 1 and an infusion assembly according to claim 12. The dependent claims describe preferred embodiments of the capsule container.

Further characteristics and advantages of the invention will be anyway apparent from the following description of some preferred embodiments, given for illustration purposes and without limitation, with reference to the accompanying drawings, in which:

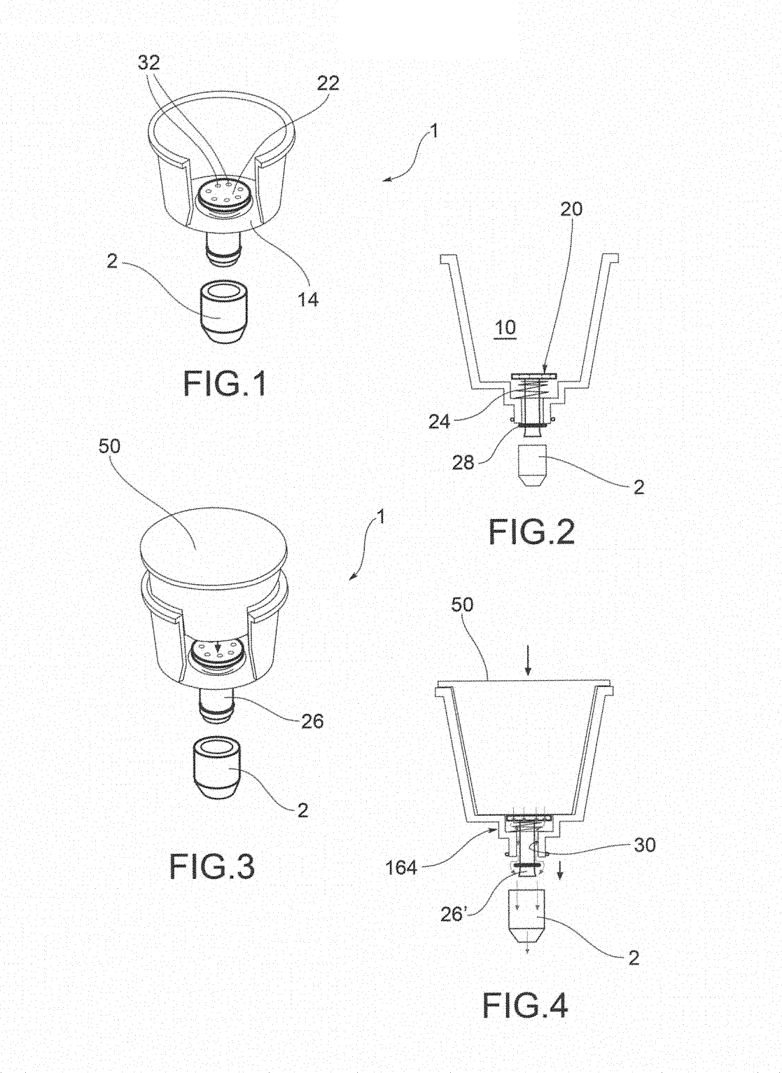

FIG. 1 is a perspective cut-away view of a capsule adapter according to the invention;

FIG. 2 is an axial sectional view of the adapter of FIG. 1 without capsule;

FIG. 3 is a perspective cut-away view of the adapter with a partially inserted capsule;

FIG. 4 is an axial sectional view of the adapter with a completely inserted capsule;

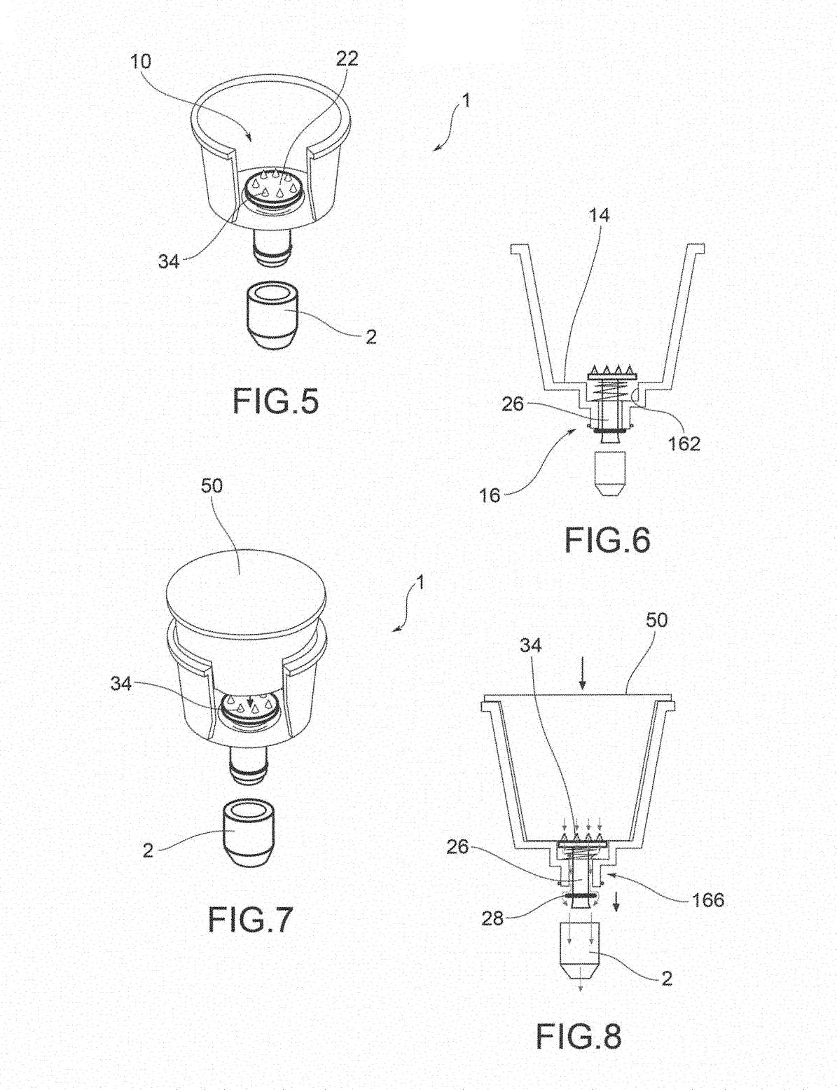

FIGS. 5-8 are views similar to the preceding ones of an adapter for capsules in an embodiment variation;

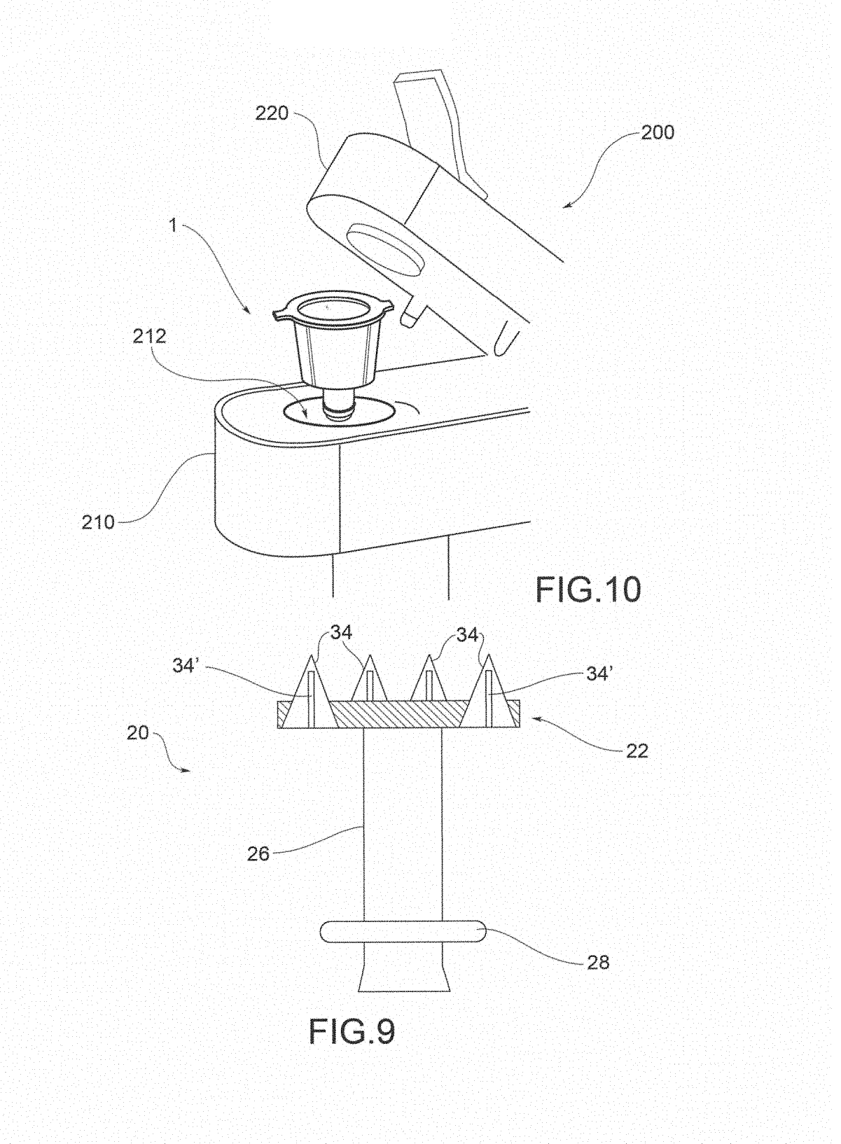

FIG. 9 is a sectional view only of the valve member of the adapter of FIGS. 5-8;

FIG. 10 is a perspective view of an adapter according to the invention during the insertion step in an infusion assembly of a machine for the delivery of an infused beverage; and

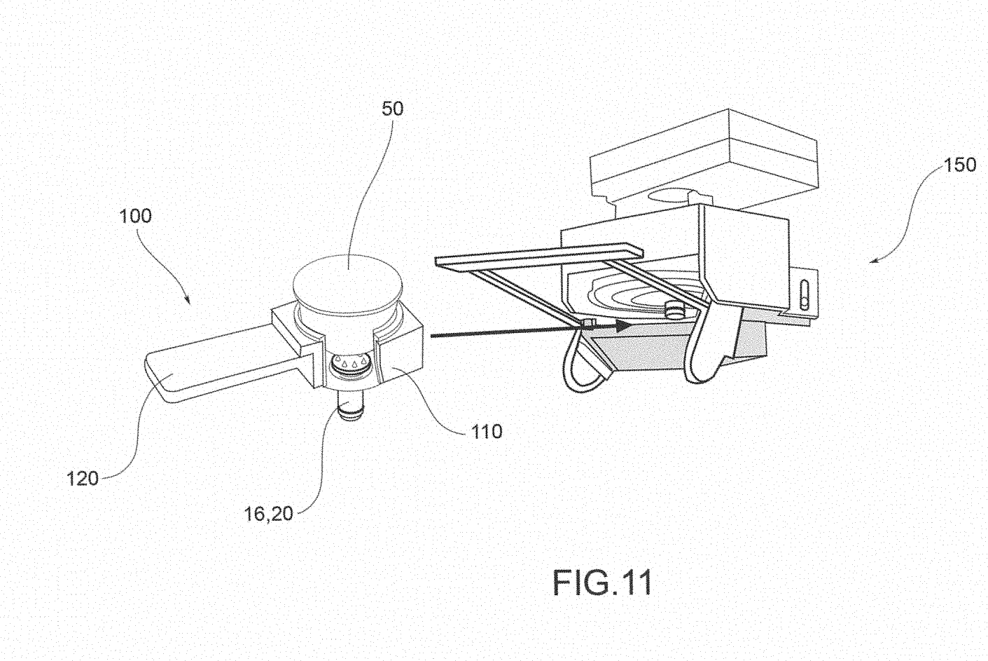

FIG. 11 is a perspective view of a capsule-holder according to the invention, the capsule being partially inserted, and a respective delivery machine of an infused beverage.

During the following description, common elements of the various embodiments of the invention are denoted with the same reference numerals.

Referring to FIGS. 1-10, numeral 1 denotes a capsule adapter adapted to be used with an infusion assembly 200 for machines of the type employing capsules or pods containing aromatic essences.

FIG. 10 shows an example of an infusion assembly 200. Usually, an infusion assembly 200 comprises a female infuser 210 defining an infusion chamber 212 adapted to house a capsule or pod for the production of an infused beverage, and a male infuser 220 adapted to cooperate with the female infuser 210 for closing the infusion chamber 212 at least partially.

At least one of the male 220 and female 210 infusers is a movable infuser. The movable infuser, in the shown embodiment being for example the male infuser 220, is movable between an open position and a closed position of the infusion chamber 212.

In the example depicted in FIG. 10, the female infuser 210 is obtained in a fixed part of the frame, whereas the male infuser 220 is obtained in a movable part hinged at the fixed part so that to be rotatable between a lowered position closing the infusion chamber 212 and a raised position opening the chamber 212.

The adapter 1 can be inserted in the female infuser 210 and is adapted to accommodate a capsule or pod 50. The capsule or pod 50 that can be inserted in the female adapter 210 can have smaller size than the capsule or pod provided for the female infuser, or it can have the same size but is usable with a different infusion technique.

Then the adapter 1 delimits a capsule housing compartment 10 adapted to receive a capsule or pod 50 by shape coupling therewith. In an embodiment, the adapter 1 generally has truncated-conical or cylindrical shape.

The adapter 1 has a bottom wall 14 in which at least one output passage 16 for the infused beverage is obtained. The output passage 16 is adapted to fluidically communicate with a hopper 2 through which the infused beverage is delivered. The output passage 16 is engaged by a valve member 20 axially translatable between a closed position of the output passage 16, when there is no capsule 50 in the housing compartment 10, and an open position of the output passage 16 when there is a capsule in the housing compartment.

When the valve member 20 is in the closed position, no liquid passes to the hopper 2. In a preferred embodiment, the valve member 20 is elastically biased so that is remains in the closed position. In other words the valve member 20, when no force is acting thereon, stays or comes back to the closed position.

In an embodiment, the valve member 20 comprises a plate 22. For example, the plate 22 is disc-shaped.

When there is no capsule, the plate 22 is elastically biased to a forward position with respect to the bottom wall 14 in the housing compartment 10.

For example, the plate 22 extends in a plane parallel to that of the bottom wall 14. Preferably, the plate 22 extends in a plane parallel to that of the bottom wall 14, so that to be axially spaced from the bottom wall 14.

In an embodiment, when the valve member 20 is in the closed position (FIGS. 2 and 6), the plate 22 is raised with respect to the bottom wall 14. When the valve member 20 is in the open position (FIGS. 4 and 8), the plate 22 is coplanar to the bottom wall 14.

In an embodiment, in the output passage 16 a spring seat 162 is obtained in which a spring 24 acting on the plate 22 is placed, for example a cylindrical or truncated-conical spring. The spring 24 can be compressed so that to allow the plate 22 to move back from the forward position to a rearward position, i.e. a coplanarity position, of alignment with the bottom wall 14 (FIGS. 4 and 8).

Therefore, in a preferred embodiment, the displacement of the valve member 20 to the rearward position opening the output passage 16 is due to the capsule 50 itself when, the latter having been inserted in the housing compartment 10, the infusion assembly 200 is closed and the capsule 50 is pushed to abutment against the bottom wall 14 of the housing compartment 10.

In an embodiment, the valve member 20 comprises a stem 26 extending in the output passage 16 and supporting, at a free end thereof, a sealing element 28, for example an O-ring, adapted to seal the output passage 16. In an embodiment, the stem 26 extends from the plate 22 and has a free end 26′ protruding from the output passage 16.

The stem 26 is movable with the plate 22 between a rearward position, in which the sealing element 28 engages the output passage 16, and a forward position, in which the sealing element 28 disengages from the output passage 16, thus allowing the passage of the infused beverage.

In an embodiment, the stem 26 is coaxial to the output passage 16 and forms, with the inner wall of this output passage 16, an annular output chamber 30 through which the infused beverage passes before reaching the hopper 2.

In an embodiment, the output passage 16 comprises a first portion 164 open towards the housing compartment 10, which forms the spring seat 162 and has, at least next to its opening to the capsule housing compartment 10, a perimeter corresponding to the plate 22 one.

The output passage 16 further comprises a second portion 166 open towards the hopper 2, which has a cross section underneath the first portion, so that a rest plane of the spring 24 is formed between the first and the second portions.

In an embodiment, the spring 24 is positioned around a proximal portion of the stem 26. According to an embodiment depicted in FIGS. 1-4, the plate 22 has one or more through-holes 32 for the passage of the infused beverage.

In an embodiment depicted in FIGS. 1-4, the plate 22 provided with the holes 32 has diameter equal to that of the first portion 162 of the output passage 16; the infused beverage being in the infusion chamber enters the output passage 16 when the valve member is in the open position through the holes 32 in the plate 22.

In an embodiment depicted in FIGS. 5-9, the plate 22 is provided, in addition or as an alternative to the holes 32, with tips 34 for piercing the capsule 50 and allowing the output of the infused beverage or the input of the infusion beverage in the capsule 50, if the latter is not provided with apposite holes intended for such a function.

In an embodiment the tips 34 are hollow, cross the whole thickness of the plate 22 and, in their conical portion, one or more openings 34′ are obtained, for example having the shape of longitudinal slits, for example three slits angularly spaced from one another, which allow the passage of the infused beverage from the capsule 50 to the output passage 16, as depicted by the arrows of FIG. 8, and which can also have the function of beverage filtration by holding the substance powders inside the capsule 50.

FIG. 10 shows a capsule-holder 100 adapted to accommodate a capsule 50 and to be connected to the machine 150 for the delivery of an infused beverage.

The capsule-holder 100 has a capsule container 110 having the same structure of the afore described adapter 1.

Therefore, the capsule container 110 delimits a capsule housing compartment 10 having a bottom wall 14, in which the at least one output passage 16 of the infused beverage is obtained and the afore described valve member 20 engages.

The capsule-holder 100, for its hand manipulation, is equipped with a side handle 120 to be gripped.

Although the present invention is particularly effective when applied to a capsule adapted 1 or a capsule-holder 100, it is evident that the output passage 1′ combined with the valve member, as all described above, can be implemented directly in a infusion assembly 200. In this case, the output passage is in fluidic communication with the infusion chamber in which the capsule or pod is inserted.

In any case, thanks to the valve member 20, the not-controlled leakage of the beverage from the adapter, capsule-holder or infusion chamber during the opening of the infusion assembly to draw out the used capsule or to remove the capsule-holder from the machine, is stopped.

Moreover the plate, elastically urged to come back to the position raised with respect to the bottom wall of the capsule housing compartment, aids the capsule extraction from this housing compartment when the infusion assembly is opened.

To satisfy contingent needs a person skilled of the art can make changes, adaptations and element substitutions with other equivalent ones to the embodiments of the capsule container according to the invention, without departing from the scope of the following claims. Each features described as belonging to a possible embodiment can be implemented independently from the other described embodiments.

Claims

1

-

11

. (canceled)

12. Capsule container for producing an infused beverage by an infusion assembly operating with a capsule or pod (50) containing an aromatic substance, said capsule container delimiting a housing compartment (10) to house the capsule, the housing compartment being adapted to receive a capsule or pod (50) by shape coupling therewith and having a bottom wall (14) in which at least one output passage (16) for the infused beverage is obtained, wherein said output passage (16) is engaged by a valve member (20) axially translatable between a closed position of the output passage, when there is no capsule in the housing compartment, and an open position of the output passage when there is a capsule in the housing compartment; said valve member (20) comprising a plate (22) that, when there is no capsule, is elastically biased to a forward position in which it protrudes with respect to the bottom wall (14) in the housing compartment (10).

13. Capsule container according to claim 12, wherein said valve member (20) is elastically biased so that it remains in the closed position.

14. Capsule container according to claim 12, wherein in the output passage (16) a spring seat (162) is obtained in which a spring (24) acting on the plate (22) is positioned, said spring being compressible so that to allow the plate to move back from the forward position to a rearward position aligned with the bottom wall.

15. Capsule container according to claim 12, wherein said valve member (20) comprises a stem (26) extending in the output passage and supporting, at a free end thereof, a sealing element (28) adapted to close the output passage.

16. Container according to claim 15, wherein said stem (26) extends from the plate and has the free end protruding from the output passage (16), the stem being movable with the plate between a rearward position, in which the sealing element (28) engages the output passage and blocks it, and a forward position, in which the sealing element (28) disengages from the output passage (16).

17. Capsule container according to claim 12, wherein the plate (22) has one or more through-holes (32) for the passage of the infused beverage from the capsule (50) to the output passage (16).

18. Capsule container according to claim 12, wherein the plate (22) is provided with piercing tips (34) to pierce the capsule.

19. Capsule container according to claim 18 wherein openings (34′), which are shaped to allow the passage of the infused beverage or an infusion beverage through the plate (22), cross said piercing tips (34).

20. Capsule container according to claim 12, adapted to be inserted in a female infuser (210) cooperating with a male infuser (220) in an infusion assembly (200) of a machine for producing and delivering an infused beverage.

21. Container according to claim 12, comprising a side handle (120) to be gripped for the application and the removal of the former to/from the infuser of a vertical machine (150) for producing an infused beverage.

22. Infusion assembly for producing an infused beverage from a capsule, comprising a female infuser (210) defining an infusion chamber (212) adapted to house a capsule or pod for the production of an infused beverage, and a male infuser (220) adapted to cooperate with the female infuser for closing said chamber at least partially, wherein said infusion chamber is made to have a capsule container (1) according to claim 12.

23. Capsule container according to claim 13, wherein in the output passage (16) a spring seat (162) is obtained in which a spring (24) acting on the plate (22) is positioned, said spring being compressible so that to allow the plate to move back from the forward position to a rearward position aligned with the bottom wall.

24. Capsule container according to claim 13, wherein said valve member (20) comprises a stem (26) extending in the output passage and supporting, at a free end thereof, a sealing element (28) adapted to close the output passage.

25. Capsule container according to claim 14, wherein said valve member (20) comprises a stem (26) extending in the output passage and supporting, at a free end thereof, a sealing element (28) adapted to close the output passage.

26. Capsule container according to claim 13, wherein the plate (22) has one or more through-holes (32) for the passage of the infused beverage from the capsule (50) to the output passage (16).

27. Capsule container according to claim 14, wherein the plate (22) has one or more through-holes (32) for the passage of the infused beverage from the capsule (50) to the output passage (16).

28. Capsule container according to claim 15, wherein the plate (22) has one or more through-holes (32) for the passage of the infused beverage from the capsule (50) to the output passage (16).

29. Capsule container according to claim 16, wherein the plate (22) has one or more through-holes (32) for the passage of the infused beverage from the capsule (50) to the output passage (16).

30. Capsule container according to claim 13, wherein the plate (22) is provided with piercing tips (34) to pierce the capsule.

31. Capsule container according to claim 14, wherein the plate (22) is provided with piercing tips (34) to pierce the capsule.
